(19) United States
(12) Patent Application Publication
(10) Pub. No.: US 2005/0010663 A1
(43) Pub. Date: Jan. 13, 2005

(54) Systems and methods for physical location self-awareness in network connected devices

(76) Inventors: Lance A. Tatman, Fremont, CA (US); James W. Davis, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/618,250

(22) Filed: Jul. 11, 2003

(51) Int. Cl. G06F 15/173

(52) U.S. Cl. 709/224

(57) ABSTRACT

A system for physical location self awareness in network connected devices comprises a location server acquiring locations of the devices from a real-time location system (RTLS) and an agent running on each of the devices, the agent querying the location server for a location of the device and storing location information for the device on that device. The system may comprise a plurality of RTLSs and a hierarchical server for searching for a location of a device starting from a last known location server outward. A method for providing location self awareness in network connected devices comprises establishing a location server for acquiring a location of the device from an RTLS, executing an agent on the device, instructing the device to send a query to the location server for location information for the device, and storing the location information for the device on the device.

### TECHNICAL FIELD

The present invention is generally related to real-time tracking systems and specifically related to systems and methods for physical location self-awareness in network connected devices.

### BACKGROUND OF THE INVENTION

Problematically in computer data centers, where hundreds or thousands of different machines are housed, specific devices are difficult to locate. Therefore, when technicians are dispatched from the various companies housing machines in the data center, the technicians waste time and effort locating the equipment they have been dispatched to service. These data centers are typically multi-thousand square foot facilities with equipment housed in racks that all generally look alike. Additionally, this equipment may not be labeled very clearly or not labeled at all.

Existing real-time tracking systems typically use electronic or infrared tracking tags, physically placed on equipment. One such existing real-time tracking system is a Real-time Location System (RTLS) from Ameritrac Wireless Corporation (see http://www. ameritracwireless.com/index.html). Such existing tracking systems constantly monitor location of the equipment tags, via triangulation, using antennas dispersed throughout the data center. Global Positioning Satellite (GPS) based systems are also available. However, location information provided by these existing systems is typically maintained in a central database, useful only to those with access to the database. In the case of a data center, there are typically hundreds of customers with equipment located on-site. Problematically, each customer may not have access to the location database.

Whereas, existing tagging systems typically employ a central server and the central server keeps track of where all the tagged items are located, the tagged items themselves contain no information on their location unless it has been manually entered. Therefore, under existing tracking systems one would not be able to access this information if the central server was down or otherwise unavailable.

Existing canonical systems for equipment tracking employ manual entry of equipment locations into a central database. An enhancement to existing canonical systems employs Simple Network Management Protocol (SNMP). The canonical location information may be stored in one of the SNMP Management Information Base (MIB) variables such as Syslnfo on the system being tracked as a place holder for device location. However, this data is typically manually entered by the operator of the equipment. If the equipment gets moved it is not necessarily updated, unless the operator is aware of the move and manually performs the update. Thus, use of SNMP MIB in this manner is fraught with update problems. Typically, once the data is set up, it does not remain current.

### BRIEF SUMMARY OF THE INVENTION

The present invention is directed to systems and methods by which a piece of equipment connected to a network may be populated automatically with near real-time information detailing the equipment's own physical location. Applications of the present systems and methods may include use in computer data centers where hundreds or thousands of computers are centrally located in a multi-thousand square foot facility, or for enterprise or government IT inventory systems. While each customer of such a facility may not have access to the location database for the facility, they typically have network access to their own equipment. Implementation of the present systems and methods will allow customers to track the physical location of their own equipment, by making queries to that equipment, without a need to access a central database. The present systems and methods also provide a backup to the central database system. If one wishes to know the location of their equipment at a time when the database is down, they may still query their equipment to get its last known location.

As used herein, “self awareness” or “awareness” is information integrated into the device on which a location system tag is placed, such that the object can report back its own location when it is queried, thereby portraying that the device is “aware” of its location.

The present systems and methods may make use of a current real-time tracking system such as the aforementioned RTLS technology from Ameritrac Wireless. The present systems and methods employ or create a location server. The present invention and its location server may operate as an extension of an existing RTLS service, as a separate system, or both. In accordance with embodiments of the present invention, tagged items query the location server on startup and internally store their own location information. This information may be accessed via a shell account from the managed system. Alternatively, if the device is managed via a protocol such as SNMP, the information may be stored on the system being tracked in one of the SNMP MIB variables, such as SysInfo.

Most existing real-time location systems employ a centralized server on which to store location data, in the aforementioned central database. One advantage of the present invention is that if that server is unavailable, the devices themselves have their last known location information. Therefore, a user that has access to a device can access location information for that device.

In some embodiments, software on a tagged object periodically seeks out, from the tracking system information repository, the device's location and programs that into the SNMP variables of that object. In other embodiments, the tagged object, as part of its boot procedure, queries the tracking system information repository for its location and stores this location internally. In the case, for example, of a device on which a software agent cannot be running at all times, the device may be able to find its location by running an application at boot, as a part of its boot procedure. Both embodiments may be combined, in that an object can find its location at boot and periodically thereafter update that information, or either embodiment can be used separately.

In various embodiments, software of the present invention directly queries a tracking system server. In other embodiments where no single RTLS system covers a domain, a hierarchical or hybrid server that can query all the RTLS servers in the domain may be employed to perform hierarchical searches and similar functions. For example, a device's previous location may be known, so the hierarchical server may start with the RTLS system associated with that location and then work outwardly through the domain, rather than querying all tracking system servers in the domain. When several real-time location systems are employed throughout, for example, a campus, one system in, for example, each building, would have a server in each domain (building). These domains may be set up in hierarchies, similar to the domain name system of the Internet, for example. A device would initially query its last known local location server, and if that location server was unavailable it would then be redirected to another location server upward in the hierarchy until it found the authoritative location server for itself. Particularly, in accordance with such an embodiment, the hierarchical server will query the next closest server and work outwardly in a circular pattern similar to the Internet's Domain Naming System (DNS) hierarchy.

An advantage of the present systems and methods is that the location data is automatically updated on the devices, and the device is thus “self aware”. Another advantage of the present systems and methods is that since devices are “aware” of their own location, if they are moved, the system does not need to be manually updated. This system takes advantage of any real-time location system that is already in place and updates the device itself. Also, since the information is stored in the device's MIB, or the like, the device is “aware” of its location even when the location system is temporarily down. Another advantage of the present invention is that when set up in a hierarchy, it is able to function across multiple real-time location system domains.

Another advantage is that multiple different, possibly even physically incompatible, location systems may use or make concurrent use of the present invention. For example, two companies, which have each set up real-time location systems, may use different location system products. For example, one company may use an infrared system and the other a radio or GPS based system. If the companies merge, or merge some of their resources (equipment), devices start migrating between company campuses. Once the companies install the physical component(s) or tags needed to track the devices, then a dual tagged device can be located across either system yet the software of the present invention does not have to be updated to work with another location system. The software of the present invention uses the same protocol and the local servers integrate the heterogeneous location systems.

If a channel is provided via which the location server can contact the device directly, a device may be enabled to react to movement of the device, whereas in a manual system or in all the existing location systems, the device would “know” nothing about its movement. Regardless, under the present system and methods, as long as the device is powered back up, it will be aware of its new location. However, a battery powered device such as a laptop computer might be continuously aware of its location. Resultantly, the present invention might also function as a security system or to supplement a security system. For example, a laptop that has been set-up to alert the present system if it leaves the building, or otherwise defined area, as it leaves the building or area it can alert the system of its departure.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow chart of operation of an embodiment of the present invention;

FIG. 2 is a diagrammatic representation of a data center employing an embodiment of the present invention; and

FIG. 3 is a diagrammatic representation of multiple domains employing a hierarchical embodiment of the present invention.

### DETAILED DESCRIPTION OF THE INVENTION

The present systems and methods provide a mechanism by which equipment connected to a network may be automatically populated with near real-time information detailing its own physical location. Embodiments may be implemented to provide devices with the capability to become aware of their own physical location. Some embodiments might be particularly useful for devices such as personal computers, workstation, or the like, which can be set to run a software agent on startup. Other embodiments implement new code into device firmware, device Basic Input/Output Operating System (BIOS), or the like, to enable the device to probe for a location server on startup. This type of equipment may include routers, switches, or any other networked devices on which a user cannot easily install new code and/or which may not be capable of running a software agent.

In these embodiments, a location server will preferably be in place, in accordance with the present invention. The location server may be an extension of services provided by an existing, in place, RTLS system. Alternatively, the location server can be a separate system that either contains a duplicate of the RTLS database or that can query the RTLS database as needed. As a further alternative, the present invention may make use of both a location server that is an extension of an existing RTLS system and a separate location server.

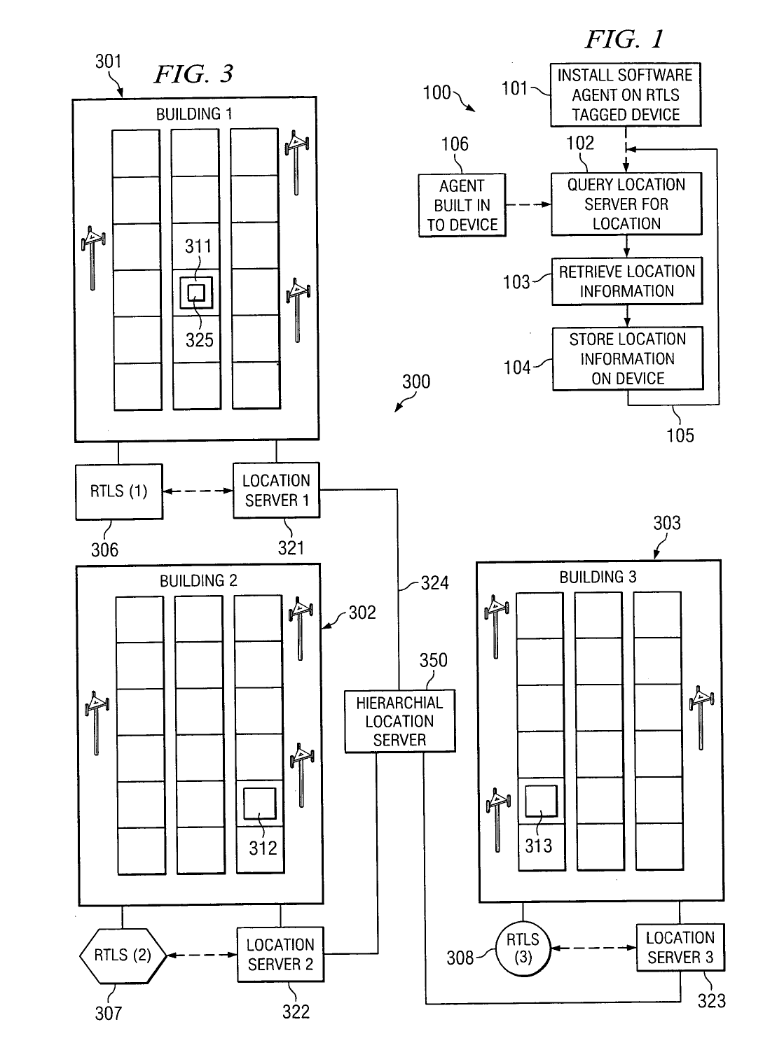

FIG. 1 is a flow chart of operation 100 of embodiments of the present invention. With a location server in place, under some embodiments of the present invention a software agent is installed on the device to be tracked at 101. This agent preferably instructs the device to send a query at 102, via network connectivity to the location server in order to discover its location. Once this information is retrieved at 103, it is either stored in a local variable, or if the machine is managed via SNMP, or the like, placed in a local MIB variable, or the like, at 104. The agent may poll (105) the location server at programmable intervals, preferably by repeating step 102 above, to maintain current location information at least internally, preferably by repeating steps 103 and 104 above.

In other embodiments, the device employs a built-in agent process 106 that immediately searches for a location server at 102, preferably in a manner similar to the Dynamic Host Configuration Protocol (DHCP), upon power-up. Again, the device would populate either a local variable or a MIB variable to store this information at 104, once it is retrieved at 103. In one embodiment the device would also poll for current data at programmable intervals (105). As with the embodiments previously described, this location information may also be updated on the location server during the periodic location updates.

Users of the system may either use standard SNMP MIB enabled browsers to retrieve location information directly from the device, or if the device is not managed via SNMP, they may access a shell account, or the like, and view the system variable.

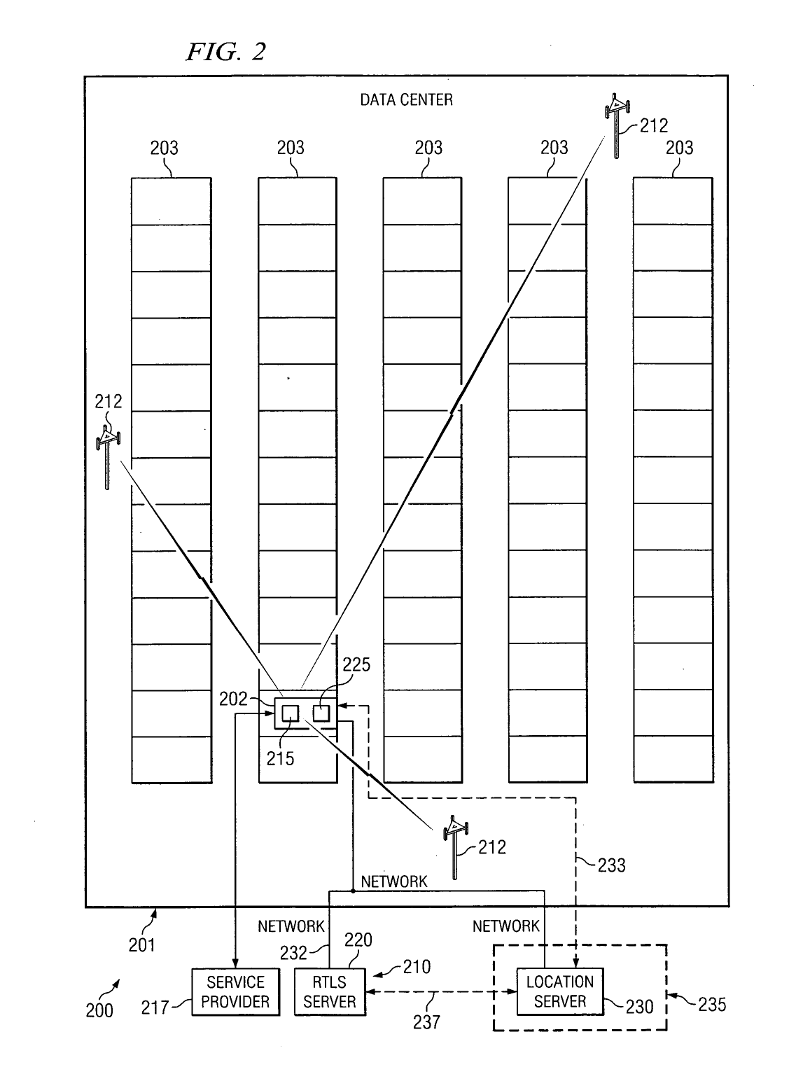

FIG. 2 is a diagrammatic representation of data center 201 employing embodiment 200 of the present invention. Devices, such as example device 202, are located in large data center 201, which may be a single large building that houses thousands of different pieces of network equipment and/or equipment racks 203 with many pieces of equipment in each rack. Such a data center may already be using real-time location system 210. This real-time location system generally comprises receivers/antennas 212 mounted at various locations in the building and centralized server 220. Each device that is installed in the data center may be tagged with whatever technology that this particular RTLS uses, tags 215 such as a Radio Frequency (RF) transponders, or the like. In accordance with the present invention each device 202 to be provided location self awareness has software agent functionality or process 225 installed or incorporated into device 202. Agent 225 is used to gather location information from location server 230.

As an example, PC 202 located in a rack in building 201 has tag 215 on it. In this example PC 202 belongs to service provider 217. Tag 215 is communicating PC 202's location to an existing RTLS 210. RTLS system 210 has a collection point typically in the form of a centralized server 220 where the data is kept for all of the devices in the building, including PC 202. Server 220 may make that data available via the web or via some specific application that may be accessed locally, through a network, or via a dial-up connection or in other manners known in the art. Software agent 225, installed on PC 202, will, upon boot of PC 202, issue a query for location server 230 via network 232 or other connectivity 233. Location server 230 responds with that device's location, which is concurrently or which has been previously retrieved from RTLS server 220 via connectivity 237 or network 232.

Agent 225 queries a location server application, which may be either software located on central RTLS server 220 or a similar application located on separate system 235. Agent 225 on the device to be located queries location server 230 upon boot up. Location server 230 preferably keeps a database of information related to the locations of the devices. That information is obtained or has previously been obtained from tracking system 210 server 220. Location server 230 feeds this location information back to device 202. Device 202 stores that data in an MIB or in a specialized application in accordance with embodiments of the present systems and methods.

Periodically, at a programmable time and/or interval, agent 225 preferably prompts device 202 to query location server 230 for the latest location information for device 202. Alternatively, location server 230 may push updates out to devices any time its data changes, via network 232 or other connectivity 233. In the case of a security application or the like, pushing updates might be advantageous.

FIG. 3 is a diagrammatic representation of multiple domains employing hierarchical embodiment 300 of the present invention. A large data center installation, or the like, might be spread over multiple areas, such as buildings or data centers 301, 302 and 303, which may be configured similar to data center 201 of FIG. 2. Such areas may be too large for one tracking system to cover. Thus, multiple RTLSs 306, 307 and 308, similar to RTLS 210 of FIG. 2, may be employed in such an installation. The organization of installation devices 311, 312, 313 may not match the organization of an RTLS communications infrastructure of the overall installation. Resultantly, devices might not be communicating with the “correct” location server 321, 322 or 323. To deal with this issue locations servers 321, 322, 323 in an installation may be configured to be aware of each other in an organizational structure, for example in a hierarchy, web, community, or the like, which may employ a network or other connectivity (324) which in turn may or may not be a part of the installation. In accordance with this embodiment when a location server (321, 322 or 323) is queried for information not directly known by that location server, the location server should return an answer obtained from the correct location server as detailed below.

By way of example, on boot-up or whenever agent 325, on device 311, “wants” location data, it contacts the closest network location server. To do so, agent 325 sends a request out onto a network (not shown, for clarity) for a location server. Closest location server 321, 322 or 323, in the network sense, not necessarily in the physical sense, responds. Network topologies do not always match the physical topological locations of network devices. Agent 325 queries the responding location server 321, 322 or 323 for its device's location. The location server queries its associated RTLS system (or its internal database of RTLS data) and the RTLS system presently returns the device's location as described in greater detail above. If the data is not available to the location server, hierarchical location server 350 queries the next RTLS data system upward in the hierarchy, which queries any sub-location servers it has under it, to determine the device's location.

In the case of a response, the response is sent back to the originating location server and then to the originating agent on the device. If the device's location is not found, the process is repeated one more level up in the hierarchy. The query is preferably sent along all paths. As a preferable optimization, the query is not sent to the server that sends the request.

For example, on boot, agent 325 on device 311 requests location data by contacting the closest network location server (321). Agent 325 queries responding location server 321 for device 311 's location. The location server queries its associated RTLS system 306 (or its internal database of RTLS data). If the location data is not available to location server 321, the location server queries the next RTLS data system upward in the hierarchy via hierarchical location server 350 to determine the device's location. In FIG. 3 the next RTLS server up in the hierarchy might be RTLS 307 and/or RTLS 308, depending on the hierarchy arrangement of the data center areas 301, 302 and 303 of the installation. In this example, using FIG. 3, RTLS 307 or RTLS 308 should return the device's location.

In a push embodiment, when the location server changes for a device, the location server that previously served a device can be informed of the location server reassignment. This notification can be made by the new location server. Then when the device reboots, since it remembers the last location server, that previous location server may provide the new server with the device's current location. Additionally or alternatively, this location update information may be pushed out to the moved device itself.

As an example, in FIG. 3, if device 311 had been moved from area 303 to area 301, RTLS 308 location server 323 may inform location server 321 that device 311 is now in RTLS server 306's area (301). Thus when device 311 boots, if it seeks out its old location server (323), server 323 may return the device's correction location (and new local server assignment, 306). Alternatively, if the update was pushed directly to device 311 it will be “aware” of its new location.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system for physical location self awareness in network connected devices, said system comprising:
a location server acquiring locations of said devices from a real-time location system; and
an agent operable to run on each of said devices, said agent querying said location server for a location of said device and storing location information for said device on said device.

2. The system of claim 1 wherein said location server maintains said locations of said devices in a database.

3. The system of claim 2 wherein said location server acquires said locations of said devices when said location server is established.

4. The system of claim 1 wherein said location server acquires said location from said real-time location system upon said agent querying said location server for a location of said device.

5. The system of claim 1 wherein said location server is an extension of said real-time location system.

6. The system of claim 1 wherein said agent is software executed by said device.

7. The system of claim 1 wherein said agent is a process incorporated into said device.

8. The system of claim 7 wherein said agent is incorporated into firmware of said device.

9. The system of claim 1 wherein said agent queries said location server on boot of said device.

10. The system of claim 1 wherein said agent periodically queries said location server.

11. The system of claim 1 wherein said agent stores said location of said device in memory of said device.

12. The system of claim 1 wherein said agent stores said location of said device in mass storage of said device.

13. The system of claim 1 further comprising said real-time location system comprising:
a tag associated with each device to be tracked;
a plurality of receivers, said receivers locating each of said tags; and
a central database of locations of said tagged devices.

14. The system of claim 13 wherein said location server is an extension of said real-time location system.

15. The system of claim 13 wherein said location server comprises a duplicate of said central database.

16. The system of claim 1 wherein said location server pushes location information updates to devices when location data on said location server changes.

17. The system of claim 1 wherein said location information stored on said device is accessible by a user networked to said device.

18. The system of claim 17 wherein said location information is accessible by said user via a shell.

19. The system of claim 17 wherein said location information is accessible by said user via a simple network management protocol.

20. The system of claim 19 wherein said location information is stored in a simple network management protocol management information base variable.

21. The system of claim 20 wherein said variable is system information for the device.

22. The system of claim 1 further comprising a plurality of real-time location systems.

23. The system of claim 22 further comprising a location server associated with each of said real-time location systems and a hierarchical server for searching for a location of a device starting from a last known location server outward to a next closest location server.

24. A method for providing location self awareness in a network connected device, said method comprising:
establishing a location server for acquiring a location of said device from a real-time location system;
executing an agent on said device;
instructing, by said agent, said device to send a query to said location server for location information for said device; and
storing said location information for said device on said device.

25. The method of claim 24 wherein said executing occurs upon boot of said device.

26. The method of claim 24 wherein said instructing is repeated periodically.

27. The method of claim 24 wherein said location information is stored in memory of said device.

28. The method of claim 24 wherein said location information is stored in mass storage of said device.

29. The method of claim 24 wherein said location server acquires said device location from said real-time location system as a result of said query.

30. The method of claim 24 wherein said location server is established as an extension of said real-time location system.

31. The method of claim 24 wherein said establishing further comprises duplicating a central database of said real-time location system.

32. The method of claim 24 further comprising:
pushing, by said location server, location information updates to devices when location data on said location server changes.

33. The method of claim 32 wherein said location information updates are pushed only to devices for which location information has changed.

34. The method of claim 24 further comprising:
providing access to said stored location information via a network.

35. The method of claim 34 wherein said providing further comprises:
providing said access via a shell.

36. The method of claim 34 wherein said providing further comprises:
providing said access via a simple network management protocol.

37. The method of claim 24 wherein said storing comprises storing said location information as a simple network management protocol management information base variable.

38. The method of claim 37 wherein said variable is system information for said device.

39. A system for physical location self awareness in a network connected device across a domain of a plurality of related real-time location systems, said system comprising:
a plurality of location servers, each location server acquiring locations of devices under a real-time location system associated with said location server;
an agent operable to run on each of said devices, said agent on a device querying a most recent location server associated with said device for a location of said device and storing location information for said device on said device; and
a hierarchical server adapted to querying each of said location servers for a location of said devices if said nearest location server fails to return a location of said device.

40. The system of claim 39 wherein said hierarchical server queries a next closest location sever when said nearest location server fails to return a location of said device.

41. The system of claim 40 wherein said hierarchical server queries a further next closest location sever when said next closest location server fails to return a location of said device.

42. The system of claim 39 wherein a newly assigned location server pushes a location information update for a moved device.

43. The system of claim 42 wherein said location information update is pushed to a previous location server to which said moved device was assigned.

44. The system of claim 42 wherein said location information update is pushed to said moved device.

45. A method for physical location self awareness in network connected devices across a domain of a plurality of related real-time location systems, said method comprising:
establishing a plurality of location servers, each of said location servers acquiring locations of said devices under a real-time location system associated with said location server;
executing an agent on each of said devices;
instructing, by said agent, that an associated device send a query for location information of said device to a most recent location server associated with said device;
querying, by a hierarchical server, upon failure of said nearest location server to return a location of said device, each of said location servers for a location of said device; and
storing, by said agent, returned location information for said device on said device.

46. The method of claim 45 further comprising:
querying, by said hierarchical server, a next closest location sever when said nearest location server fails to return a location of said device.

47. The method of claim 46 further comprising:
querying, by said hierarchical server, a further next closest location sever when said next closest location server fails to return a location of said device.

48. The method of claim 45 further comprising:
pushing, by a newly assigned location server, a location information update for a moved device.

49. The method of claim 48 wherein said pushing is carried out in response to said device moving into said newly assigned location server's associated real-time locations system's area.

50. The method of claim 48 wherein said location information update is pushed to a previous location server to which said moved device was assigned.

51. The method of claim 48 wherein said location information update is pushed to said moved device.
